(19) United States
(12) Patent Application Publication
(10) Pub. No.: US 2012/0229434 A1
(43) Pub. Date: Sep. 13, 2012

(54) PLASMA DISPLAY DEVICE AND METHOD OF DRIVING PLASMA DISPLAY PANEL

(76) Inventor: Yoshimasa Niibo, Osaka (JP)

(21) Appl. No.: 13/509,456

(22) PCT Filed: Nov. 11, 2010
(86) PCT No.: PCT/JP2010/006625

§ 371 Date: May 11, 2012

(30) Foreign Application Priority Data
Nov. 12, 2009 (JP) 2009-258588

(51) Int. Cl. G09G 3/28; G06F 3/038

(52) U.S. Cl. 345/204; 345/60

(57) ABSTRACT

In a plasma display apparatus, a stable address discharge is caused while unnecessary radiation, e.g. line radiation and housing radiation, is suppressed. For this purpose, the plasma display apparatus includes an image signal processing circuit and a data electrode driver circuit. The data electrode driver circuit generates an address pulse based on the image data, and applies the address pulse to a data electrode, using at least one output buffer having a predetermined current supply capability for applying the address pulse to the data electrode. Further, based on the image data, the data electrode driver circuit calculates the load capacitance of the data electrode. Based on the calculated load capacitance, the data electrode driver circuit changes the number of the output buffers to be used in the application of the address pulse to the data electrode.

### TECHNICAL FIELD

The present invention relates to a plasma display apparatus of the AC surface discharge type and to a driving method for a plasma display panel.

### BACKGROUND ART

A plasma display panel (hereinafter, simply referred to as “panel”) has a front substrate and a rear substrate opposed to each other. The front substrate has a plurality of display electrode pairs, each including a scan electrode and a sustain electrode, long in the row direction. The rear substrate has a plurality of data electrodes long in the column direction. A discharge cell is formed in a position where a display electrode pair three-dimensionally intersects (hereinafter, simply referred to as “intersect”) a data electrode. A plasma display apparatus is an apparatus that has a scan electrode driver circuit, a sustain electrode driver circuit, and a data electrode driver circuit, each for driving the above panel, and displays an image by applying necessary driving voltage waveforms to the respective electrodes.

A typical driving method for the panel is a subfield method of displaying gradations by dividing one field period into a plurality of subfields and combining the subfields where light is emitted. Each of the subfields has an initializing period, an address period, and a sustain period.

In the initializing period, an initializing operation is performed so as to cause an initializing discharge and form wall charge necessary for the subsequent address operation. In the address period, an address operation is performed so as to apply an address pulse to the data electrodes corresponding to an image to be displayed and to selectively cause an address discharge in the respective discharge cells. Wall charge is formed in the discharge cells having undergone the address discharge. In the sustain period, a sustain operation is performed so as to generate sustain pulses corresponding in number to the luminance weight and to apply the sustain pulses alternately to the scan electrodes and the sustain electrodes. The sustain operation generates a sustain discharge and causes the phosphor layers to emit light in the discharge cells having undergone the address discharge. Thus, an image is displayed on the panel.

The plasma display apparatus includes electrode driver circuits specific to electrode types for generating driving voltage waveforms to be applied to the respective electrodes of the panel. The data electrode driver circuit is a driver circuit for applying an address pulse corresponding to an image signal to the respective data electrodes and causing an address discharge in the respective discharge cells. The transition time of the rising edge and the transition time of the falling edge of the address pulse generated by the data electrode driver circuit are shorter than those of a sustain pulse, for example. Thus, a large current instantaneously flows in the generation of the address pulse. This large current is likely to cause unnecessary radiation (a generic term of unnecessary electromagnetic noise emitted from an electronic device), e.g. line radiation (electromagnetic noise emitted through the power supply line) and housing radiation (electromagnetic noise emitted from the main unit of the electronic device), of electromagnetic waves.

Such electromagnetic waves, if intensely generated, have adverse effects, such as interference with other electronic devices. In order to prevent such adverse effects, the upper limit of the electromagnetic radiation is legally regulated. Further, in order to suppress the electromagnetic radiation below the regulated values, various proposals are made. For example, Patent Literature 1 discloses a plasma display apparatus structured such that a metallic back cover that has a cutout portion over the shield case is attached to the chassis member, and the metallic back cover is electrically connected to a metallic case via a conductive gasket.

However, with recent increases in the definition and size of the panel, the electric power consumption of the plasma display apparatus tends to increase. This also tends to increase unnecessary radiation, e.g. line radiation and housing radiation, of electromagnetic waves. Thus, it is difficult to sufficiently obtain the advantage of reducing the unnecessary radiation only with the above method.

### CITATION LIST

### Patent Literature

PTL1

Japanese Patent Unexamined Publication No. 2000-196977

### SUMMARY OF THE INVENTION

A plasma display apparatus includes the following elements:
a panel having a plurality of discharge cells, each of the discharge cells having a display electrode pair and a data electrode, the display electrode pair including a scan electrode and a sustain electrode; and
a driver circuit for driving the panel in a manner such that one field is formed of a plurality of subfields and each of the subfields includes an address period, the driver circuit including the following elements:
   an image signal processing circuit for generating image data that represents light emission and no light emission in each discharge cell in each subfield, based on an image signal; and
   a data electrode driver circuit for generating an address pulse based on the image data, and applying the address pulse to the corresponding data electrode.

The data electrode driver circuit includes a plurality of output buffers for each data electrode. Each output buffer has a predetermined current supply capability and applies the address pulse to the corresponding data electrode. Based on the image data, the data electrode driver circuit calculates the load capacitance of each data electrode. Further, based on the calculated load capacitance, the data electrode driver circuit changes the number of the output buffers to be used in the application of the address pulse to the corresponding data electrode.

With this configuration, the number of the buffers to be used in the generation of the address pulse can be changed in response to the load capacitance of the data electrode. Thus, when the load capacitance of the data electrode is low, excessive current supply to the data electrode can be prevented. This can suppress unnecessary radiation, e.g. line radiation and housing radiation, and cause a stable address discharge.

In a driving method for a panel,
the panel having a plurality of discharge cells, each of the discharge cells having a display electrode pair and a data electrode, the display electrode pair including a scan electrode and a sustain electrode,
the panel being driven in a manner such that one field is formed of a plurality of subfields and each of the subfields includes an address period, the driving method includes:
based on an image signal, generating image data that represents light emission and no light emission in each discharge cell in each subfield;
generating an address pulse based on the image data, and applying the address pulse to the corresponding data electrode, using at least one output buffer, the output buffer having a predetermined current supply capability;
based on the image data, calculating a load capacitance of each data electrode; and
based on the calculated load capacitance, changing the number of the output buffers to be used in the application of the address pulse to the corresponding data electrode.

With this method, the number of the buffers to be used in the generation of the address pulse can be changed in response to the load capacitance of the data electrode. Thus, when the load capacitance of the data electrode is low, excessive current supply to the data electrode can be prevented. This can suppress unnecessary radiation, e.g. line radiation and housing radiation, and cause a stable address discharge.

### BRIEF DESCRIPTION OF DRAWINGS

FIG. 1 is an exploded perspective view showing a structure of a panel for use in a plasma display apparatus in accordance with an exemplary embodiment of the present invention.

FIG. 2 is an electrode array diagram of the panel for use in the plasma display apparatus in accordance with the exemplary embodiment.

FIG. 3 is a diagram schematically showing interelectrode capacitance of the panel for use in the plasma display apparatus in accordance with the exemplary embodiment.

FIG. 4 is a chart showing driving voltage waveforms applied to respective electrodes of the panel for use in the plasma display apparatus in accordance with the exemplary embodiment.

FIG. 5 is a circuit block diagram of the plasma display apparatus in accordance with the exemplary embodiment.

FIG. 6 is a circuit block diagram of a data driver in the plasma display apparatus in accordance with the exemplary embodiment.

FIG. 7A is a circuit diagram of a self-load calculator in a load calculator in the plasma display apparatus in accordance with the exemplary embodiment.

FIG. 7B is a circuit diagram of an adjacent load calculator in the load calculator in the plasma display apparatus in accordance with the exemplary embodiment.

FIG. 7C is a circuit diagram of an output buffer controller in the load calculator in the plasma display apparatus in accordance with the exemplary embodiment.

FIG. 8 is a diagram schematically showing load capacitance generated in one data electrode in the plasma display apparatus in accordance with the exemplary embodiment.

FIG. 9A is a diagram schematically showing the generation of unnecessary radiation when a plurality of output buffers included in an address pulse generator is operated adaptively to a display image in the plasma display apparatus in accordance with the exemplary embodiment.

FIG. 9B is a diagram schematically showing the generation of unnecessary radiation when all the plurality of output buffers in the address pulse generator is always operated in the plasma display apparatus in accordance with the exemplary embodiment.

FIG. 10 is a circuit block diagram of a data driver in a plasma display apparatus in accordance with another exemplary embodiment of the present invention.

FIG. 11 is a circuit diagram of an output buffer controller in a load calculator in the plasma display apparatus in accordance with the other exemplary embodiment.

FIG. 12 is a diagram schematically showing the generation of unnecessary radiation when two output buffers included in an address pulse generator are operated adaptively to a display image in the plasma display apparatus in accordance with the other exemplary embodiment.

### DESCRIPTION OF EMBODIMENTS

Hereinafter, a plasma display apparatus in accordance with exemplary embodiments of the present invention is described, with reference to the accompanying drawings.

### Exemplary Embodiment

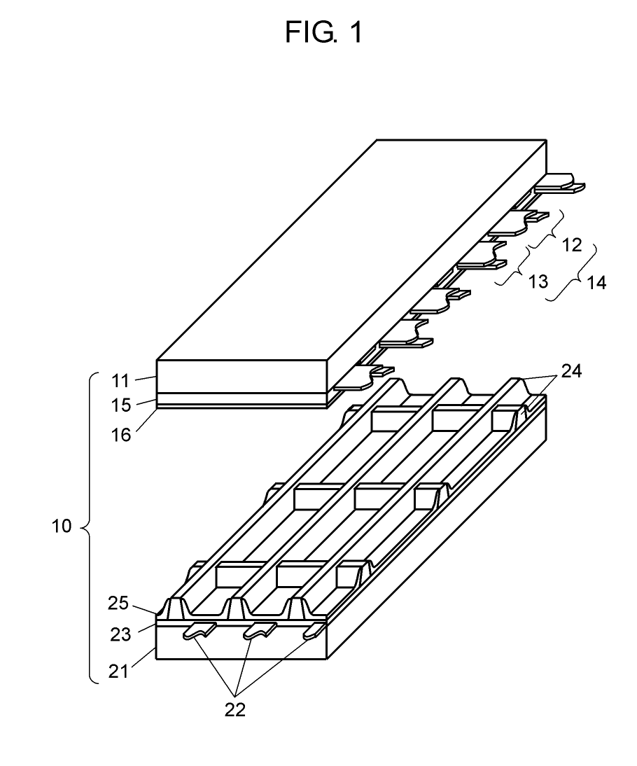

FIG. 1 is an exploded perspective view showing a structure of panel 10 for use in the plasma display apparatus in accordance with the exemplary embodiment of the present invention. A plurality of display electrode pairs 14, each including scan electrode 12 and sustain electrode 13, is disposed on glass front substrate 11. Dielectric layer 15 is formed so as to cover scan electrodes 12 and sustain electrodes 13. Protective layer 16 is formed over dielectric layer 15. A plurality of data electrodes 22 is formed on rear substrate 21. Dielectric layer 23 is formed so as to cover data electrodes 22. Further, mesh barrier ribs 24 are formed on the dielectric layer. On the side faces of barrier ribs 24 and on dielectric layer 23, phosphor layers 25 for emitting light of red color, green color, and blue color are formed.

Front substrate 11 and rear substrate 21 face each other such that display electrode pairs 14 intersect data electrodes 22 with a small discharge space sandwiched between the electrodes. The outer peripheries of the substrates are sealed with a sealing material, such as a glass frit. Into the discharge space, a mixture gas of neon and xenon, for example, is sealed as a discharge gas. The discharge space is partitioned into a plurality of compartments by barrier ribs 24. Discharge cells are formed in the intersecting parts of display electrode pairs 14 and data electrodes 22. These discharge cells discharge and emit light so as to display an image on panel 10.

The structure of panel 10 is not limited to the above, and may include barrier ribs in a stripe pattern, for example.

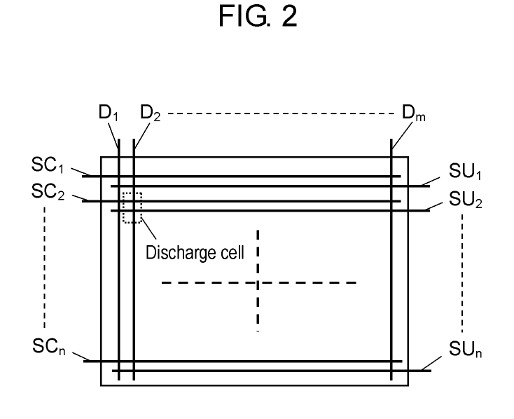

FIG. 2 is an electrode array diagram of panel 10 for use in the plasma display apparatus in accordance with the exemplary embodiment of the present invention. Panel 10 has n scan electrode SC1-scan electrode SCn (scan electrodes 12 in FIG. 1) and n sustain electrode SU1-sustain electrode SUn (sustain electrodes 13 in FIG. 1) both long in the row direction (line direction), and m data electrode D1-data electrode Dm (data electrodes 22 in FIG. 1) long in the column direction. A discharge cell is formed in the part where a pair of scan electrode SCi (i=1−n) and sustain electrode SUi intersects one data electrode Dj (j=1−m). Thus, m×n discharge cells are formed in the discharge space.

Between the electrodes thus arranged, interelectrode capacitance (capacitance generated between the electrodes, hereinafter being also simply referred to as “capacitance”) is present.

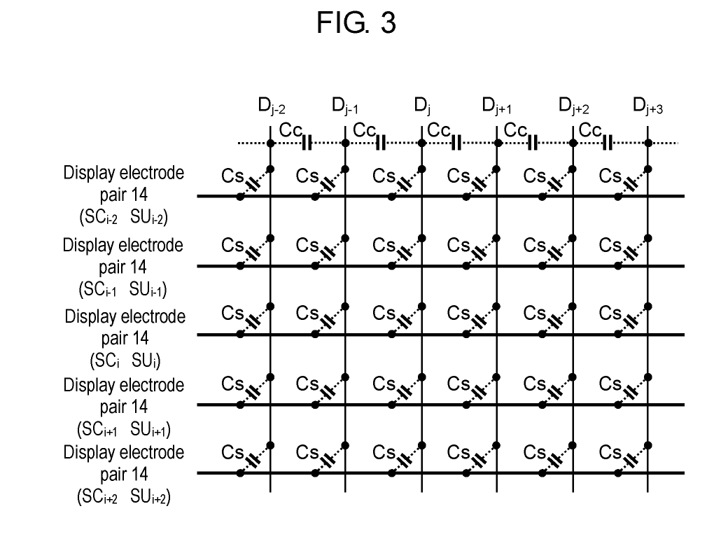

FIG. 3 is a diagram schematically showing interelectrode capacitance of panel 10 for use in the plasma display apparatus in accordance with the exemplary embodiment of the present invention. FIG. 3 shows five scan electrode SCi−2 through scan electrode SCi+2, five sustain electrode SUi−2 through sustain electrode SUi+2, and six data electrode Dj−2 through data electrode Dj+3. However, FIG. 3 shows scan electrode 12 and sustain electrode 13, with one thick line of one display electrode pair 14 instead of separate lines. FIG. 3 also shows interelectrode capacitance related to data electrode D1-data electrode Dm as capacitance Cc and capacitance Cs.

As shown in FIG. 3, in panel 10, capacitance Cs is present in the intersecting part of display electrode pair 14 and data electrode 22, and capacitance Cc is present between data electrode 22 and adjacent data electrode 22.

In panel 10, one data electrode Dj intersects n scan electrode SC1-scan electrode SCn and n sustain electrode SU1-sustain electrode SUn. Therefore, in panel 10, capacitance (n×Cs) is present between data electrode Dj and all display electrode pairs 14 (n display electrode pairs). Hereinafter, this capacitance (n×Cs) is denoted as capacitance Cg.

Thus, in one data electrode 22, capacitance Cg occurs between the data electrode and all display electrode pairs 14, capacitance Cc occurs between that data electrode and data electrode 22 adjacent on the right side, and capacitance Cc occurs between that data electrode and data electrode 22 adjacent on the left side. That is, the total load capacitance generated in one data electrode 22 amounts to capacitance Cg+2Cc, which occurs in each data electrode 22.

Next, a driving method for panel 10 is described. In this exemplary embodiment, a so-called subfield method is used as the method for displaying gradations. The subfield method is a method for displaying gradations by dividing one field period into a plurality of subfields and controlling the light emission and no light emission in each discharge cell in each subfield. Each subfield has an initializing period, an address period, and a sustain period. In this exemplary embodiment, one field is formed of eight subfields (SF1 and SF2-SF8), and the respective subfields have luminance weights of 1, 2, 4, 8, 16, 32, 64, and 128. However, this subfield structure is only an example, and the present invention is not limited to this subfield structure.

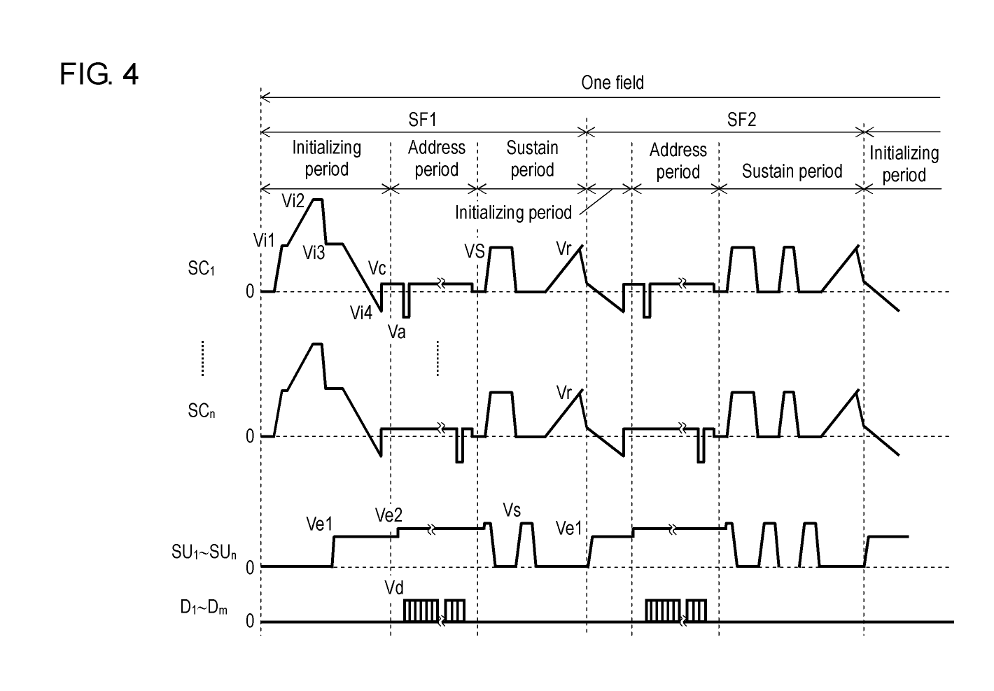

FIG. 4 is a chart showing driving voltage waveforms applied to respective electrodes of panel 10 for use in the plasma display apparatus in accordance with the exemplary embodiment of the present invention. FIG. 4 shows driving voltage waveforms in two subfields, i.e. subfield SF1 and subfield SF2.

In the initializing period of subfield SF1, voltage 0 (V) is applied to data electrode D1-data electrode Dm and sustain electrode SU1-sustain electrode SUn, and a ramp voltage gently rising from voltage Vi1 toward voltage Vi2 is applied to scan electrode SC1-scan electrode SCn. Voltage Vi1 is a voltage equal to or lower than a discharge start voltage with respect to sustain electrode SU1-sustain electrode SUn. Voltage Vi2 is a voltage exceeding the discharge start voltage with respect to sustain electrode SU1-sustain electrode SUn. This voltage application causes a weak initializing discharge between scan electrode SC1-scan electrode SCn and sustain electrode SU1-sustain electrode SUn, and between scan electrode SC1-scan electrode SCn and data electrode D1-data electrode Dm.

Thereafter, voltage Ve1 is applied to sustain electrode SU1-sustain electrode SUn, and a ramp voltage gently falling from voltage Vi3 toward voltage Vi4 is applied to scan electrode SC1-scan electrode SCn. Voltage Vi3 is a voltage equal to or lower than a discharge start voltage with respect to sustain electrode SU1-sustain electrode SUn. Voltage Vi4 is a voltage exceeding the discharge start voltage with respect to sustain electrode SU1-sustain electrode SUn. This voltage application causes a weak initializing discharge between scan electrode SC1-scan electrode SCn and sustain electrode SU1-sustain electrode SUn, and between scan electrode SC1-scan electrode SCn and data electrode D1-data electrode Dm.

In the initializing period, in this manner, a weak initializing discharge occurs in the discharge cells so as to form wall charge necessary for the subsequent address operation on the respective electrodes. As the operation in the initializing period, only the gently falling ramp voltage may be applied to scan electrode SC1-scan electrode SCn, as shown in the initializing period of subfield SF2 of FIG. 4.

In the subsequent address period, voltage Ve2 is applied to sustain electrode SU1-sustain electrode SUn, voltage Vc is applied to scan electrode SC1-scan electrode SCn, and voltage 0 (V) is applied to data electrode D1-data electrode Dm. Next, a scan pulse at voltage Va is applied to scan electrode SC1 in the first line, and an address pulse at voltage Vd is applied to data electrode Dk (k=1−m) corresponding to the discharge cell to be lit. In the discharge cell in the first line applied with the scan pulse and the address pulse at the same time, an address discharge occurs, and an address operation for accumulating wall charge on scan electrode SC1 and sustain electrode SU1 is performed. In contrast, in the discharge cells applied with no address pulse, no address discharge occurs and the wall voltage at the completion of the initializing period is maintained.

In the address period, the address operation similar to the above is sequentially performed on each line, starting from the discharge cells in the second line and reaching the discharge cells in the n-th line. Thus, an address discharge is caused selectively in the discharge cells to be lit so as to form wall charge in the discharge cells.

Data electrodes 22 as viewed from the data electrode driver circuit are capacitive loads as shown in FIG. 3. Further, as described above, the transition time of the rising edge and the transition time of the falling edge of the address pulse are shorter than those of a sustain pulse generated with a power recovery circuit, for example. Therefore, in order to generate such an address pulse, it is necessary to instantaneously supply a large current so that the load capacitance of each data electrode 22 is charged within the short transition time when the data electrode driver circuit applies the address pulse to data electrode 22. (Hereinafter, the maximum value of the instantaneously flowing current is referred to as “peak current”.) However, if a peak current excessively larger than required flows from the data electrode driver circuit to each data electrode 22, unnecessary radiation, e.g. line radiation and housing radiation, of electromagnetic waves increases. The increasing unnecessary radiation can exceed the value of a predetermined standard on unnecessary radiation, for example. Though detailed later, the plasma display apparatus in this exemplary embodiment has a configuration for suppressing such unnecessary radiation.

In the subsequent sustain period, voltage 0 (V) is applied to sustain electrode SU1-sustain electrode SUn, and a sustain pulse at voltage Vs is applied to scan electrode SC1-scan electrode SCn. With this application, in the discharge cells having undergone an address discharge, a sustain discharge occurs and the ultraviolet rays generated at this time cause phosphor layers 25 to emit light. Next, voltage 0 (V) is applied to scan electrode SC1-scan electrode SCn, and a sustain pulse at voltage Vs is applied to sustain electrode SU1-sustain electrode SUn. With this application, in the discharge cells having undergone the sustain discharge immediately before, a sustain discharge occurs again and light is emitted. Thereafter, sustain pulses corresponding in number to the luminance weight are generated and applied alternately to scan electrode SC1-scan electrode SCn and sustain electrode SU1-sustain electrode SUn. Thereby, the discharge cells having undergone an address discharge are lit at a luminance corresponding to the luminance weight.

After all the sustain pulses have been generated, a ramp voltage gently rising from voltage 0 (V) toward voltage Vr is applied to scan electrode SC1-scan electrode SCn. This voltage application causes a weak discharge in the discharge cells having undergone a sustain discharge, thereby causing so-called wall charge erasure for erasing a part or the whole of the wall charge. Thus, the sustain period is completed. In this exemplary embodiment, voltage Vr is set to a voltage equal to voltage Vs, but may be set to a voltage different from voltage Vs.

In the subsequent subfields, the operation similar to the operation in the above subfield except for the number of sustain pulses is repeated. Thus, the discharge cells are lit at luminances corresponding to the luminance weights in the respective subfields.

Next, a description is provided for a driver circuit for driving panel 10.

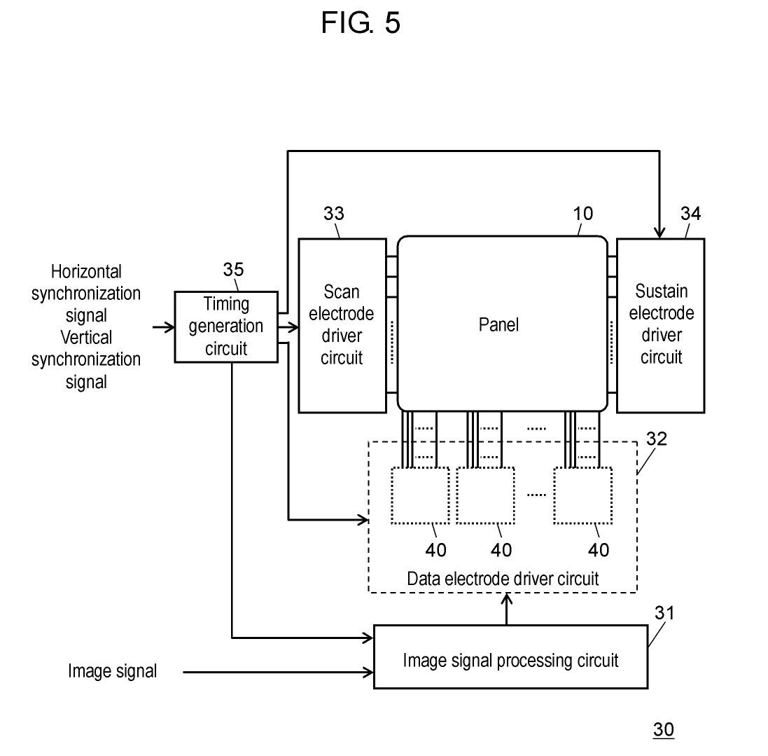

FIG. 5 is a circuit block diagram of plasma display apparatus 30 in accordance with the exemplary embodiment of the present invention. Plasma display apparatus 30 includes the following elements:
panel 10 having a plurality of discharge cells arranged therein, each discharge cell having scan electrode 12, sustain electrode 13, and data electrode 22; and
a driver circuit for driving panel 10.
   The driver circuit includes image signal processing circuit 31, data electrode driver circuit 32, scan electrode driver circuit 33, sustain electrode driver circuit 34, timing generation circuit 35, and an electric power supply circuit (not shown) for supplying electric power necessary for each circuit block.

Image signal processing circuit 31 allocates gradation values to each discharge cell, based on an input image signal, and converts the respective gradation values into image data for output. This image data is data where the light emission and no light emission in each discharge cell in each subfield are correlated with “1” and “0”, respectively, in the respective bits.

Data electrode driver circuit 32 converts the image data output from image signal processing circuit 31 into address pulses corresponding to data electrode D1-data electrode Dm, and applies the address pulses to respective data electrode D1-data electrode Dm. Data electrode driver circuit 32 is divided into a plurality of circuits such that each circuit drives a predetermined number of data electrodes 22. Each circuit is integrated into one semiconductor integrated circuit (monolithic IC). Hereinafter, this monolithic IC is referred to as “data driver”. That is, data electrode driver circuit 32 is formed of a plurality of data drivers 40. In this exemplary embodiment, the predetermined number is 384, so that a circuit for driving 384 data electrodes 22 is integrated as one data driver 40. Eight data driver circuits 40 form data electrode driver circuit 32.

Based on a horizontal synchronization signal and a vertical synchronization signal, timing generation circuit 35 generates various timing signals for controlling the operation of each circuit, and supplies the timing signals to each circuit.

In response to the timing signals supplied from timing generation circuit 35, scan electrode driver circuit 33 drives each of scan electrode SC1-scan electrode SCn.

In response to the timing signals supplied from timing generation circuit 35, sustain electrode driver circuit 34 drives each of sustain electrode SU1-sustain electrode SUn.

Next, data driver 40 is described.

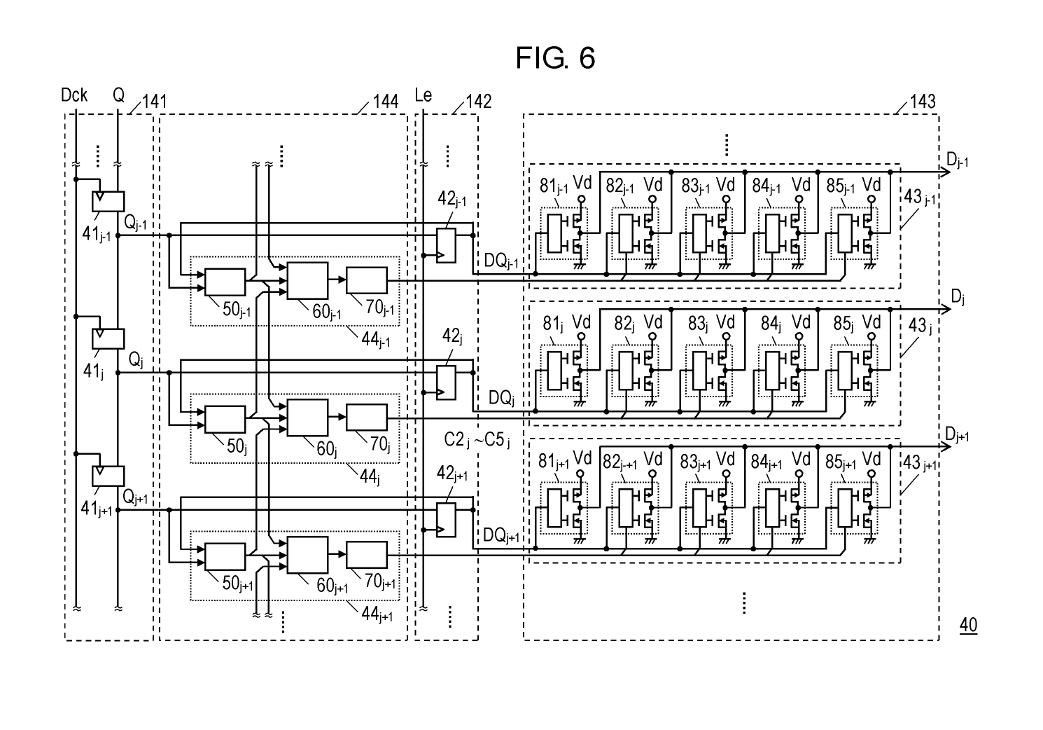

FIG. 6 is a circuit block diagram of data driver 40 in plasma display apparatus 30 in accordance with the exemplary embodiment of the present invention. Data driver 40 includes shift register part 141, data latch part 142, address pulse output part 143, and address pulse controller part 144.

Shift register part 141 has a plurality of latches 41. A change in a synchronization signal triggers each latch 41 to output an input signal. Each latch 41 receives clock signal Dck as the synchronization signal. For instance, in synchronization with the timing when clock signal Dck changes from the Lo state to the Hi state, an input signal is output. Clock signal Dck is a signal (clock signal) that repeats the Lo and Hi states in a predetermined cycle. Therefore, each latch 41 operates as a delay circuit for delaying an input signal by one clock period of clock signal Dck and outputting the delayed signal.

In shift register part 141, the plurality of latches 41 is connected in series such that the output of latch 41j is input to latch 41j+1 at the subsequent stage, for example. With this configuration, the input signal is gradually delayed with a delay time corresponding to the period of clock signal Dck in synchronization with clock signal Dck.

Shift register part 141 has latches 41 at least equal in number to data electrodes 22 to be driven by data driver 40. The shift register part gradually delays bit Q corresponding to a subfield in serially transferred image data (hereinafter, simply referred to as “image data Q”) in synchronization with clock signal Dck. The serial transfer is one of data transfer methods, in which data formed of a plurality of bits is transferred on a bit-by-bit basis. For 8-bit data, for example, eight serial digital signals (“1” or “0”) are transferred as 1-bit signal.

Therefore, in shift register part 141, serially transferred image data Q is sequentially passed through a plurality of latches 41 connected in series, and thereby the data can be delayed by one clock period of clock signal Dck. (Hereinafter, the serially transferred data is simply referred to as “serial data”.)

Here, for ease of explanation, a description is provided for the operation of one data driver 40 that drives three data electrodes 22, i.e. data electrode Dj−1, data electrode Dj, and data electrode Dj+1.

In image data Q, bit signals that represent light emission and no light emission corresponding to respective data electrodes 22 in each subfield are shown as a serial signal. Thus, in this example, image data Q includes the data that represents light emission and no light emission in respective data electrode Dj−1, data electrode Dj, and data electrode Dj+1.

For instance, suppose, in the address operation on the n-th line in a subfield, the discharge cells corresponding to data electrode Dj−1, data electrode Dj, and data electrode Dj+1 are lit, unlit, and lit, respectively. In this case, the data “1” representing light emission is allocated to data electrode Dj−1, the data “0” representing no light emission is allocated to data electrode Dj, and the data “1” is allocated to data electrode Dj+1. Therefore, image data Q includes the temporally successive data items “1, 0, 1”.

In this manner, image data Q includes data corresponding to each of data electrodes 22 in a temporally successive state. However, an address pulse needs to be applied simultaneously to each of data electrodes 22. In the above example, the data items “1, 0, 1” need to be allocated simultaneously to respective data electrode Dj−1, data electrode Dj, and data electrode Dj+1.

The part that serves to extract the plurality of temporally successive data items at the same timing is shift register part 141. In shift register part 141, image data Q is sequentially delayed in synchronization with clock signal Dck, using the plurality of latches 41 connected in series. Therefore, at an instant, image data Qj−1 corresponding to data electrode Dj−1 is output from latch 41j−1, image data Qj corresponding to data electrode Dj is output from latch 41j, and image data Qj+1 corresponding to data electrode Dj+1 is output from latch 41j+1. In this manner, each latch 41 outputs proper image data Q corresponding to data electrode 22 connected to that latch 41.

However, at the timing of the next change in clock signal Dck, the signal output from each latch 41 changes. For example, at the next timing, image data Qj−2 corresponding to data electrode Dj−2 is output from latch 41j−1, image data Qj−1 corresponding to data electrode Dj−1 is output from latch 41j, and image data Qj corresponding to data electrode Dj is output from latch 41j+1. In this manner, if an appropriate timing is missed, image data Q that does not correspond to data electrodes 22 is output from respective latches 41.

Therefore, data driver 40 needs to perform the following operation: when each latch 41 outputs proper image data Q corresponding to data electrode 22 connected to that latch 41, this image data Q is held. Data latch part 142 performs this operation.

Data latch part 142 has latches 42 equal in number to latches 41 in shift register part 141. Latches 42 correspond to respective data electrodes 22 to be driven by data driver 40, and are connected to corresponding latches 41. For example, the output from latch 41j−1 is input to latch 42j−1 corresponding to data electrode Dj−1, the output from latch 41j is input to latch 42j corresponding to data electrode Dj, and the output from latch 41j+1 is input to latch 42j+1 corresponding to data electrode Dj+1.

Address timing signal Le generated in timing generation circuit 35 is input to each latch 42, as a synchronization signal. A change in the synchronization signal (e.g. from the Lo state to the Hi state) triggers an input signal to be output.

Address timing signal Le is a periodic pulse waveform of positive polarity normally in the Lo state and in the Hi state only in a period equal to one clock period of clock signal Dck, for example. The cycle in which address timing signal Le becomes Hi is equal to the cycle in which the address pulses are generated. Address timing signal Le is generated in timing generation circuit 35 so as to change from the Lo state to the Hi state at the timing when each latch 41 outputs proper data corresponding to data electrode 22 connected that latch 41.

Latches 42 hold the output signals in the period during which address timing signal Le is in the Lo state. Thus, in response to address timing signal Le, each latch 42 operates to output the signal output from corresponding latch 41, at an appropriate timing, and to hold the output signal. Therefore, the signal output from each latch 42 is image data DQ corresponding to data electrode 22 connected to that latch 42. For example, when image data Qj is output from latch 41j, latch 42j acquires image data Qj and outputs image data DQj corresponding to data electrode Dj.

Address pulse output part 143 has address pulse generators 43 equal in number to latches 41 in shift register part 141. Address pulse generators 43 correspond to respective data electrodes 22 to be driven by data driver 40. Each address pulse generator 43 generates an address pulse to be applied to corresponding data electrode 22 to be driven by data driver 40. For example, the address pulse output from address pulse generator 43j is applied to data electrode 22Dj, and the address pulse output from address pulse generator 43j+1 is applied to data electrode 22Dj+1.

Each address pulse generator 43 has a plurality of output buffers. The plurality of output buffers is connected in parallel with each other. That is, the respective outputs are connected to each other, and connected to the data electrodes; the respective inputs are connected to each other, and connected to the output terminals of latches 42. In this exemplary embodiment, one address pulse generator 43 includes five output buffers (output buffer 81, output buffer 82, output buffer 83, output buffer 84, and output buffer 85). However, in the present invention, the number of the output buffers is not limited to this number.

Each output buffer includes a switching element for outputting voltage Vd on the high voltage side of the address pulse, and a switching element for outputting voltage 0 (V) on the low voltage side of the address pulse. By outputting voltage Vd on the high voltage side or voltage 0 (V) on the low voltage side, the address pulse at voltage Vd is generated. Each output buffer applies the address pulse to corresponding data electrode 22 by connecting data electrode 22 to voltage Vd or voltage 0 (V), based on image data DQ. In FIG. 6, each of these switching elements is denoted by a mark representing a field effect transistor (FET).

In this exemplary embodiment, output buffer 81 is an output buffer that has a current capacity (current supply capability) capable of driving a capacitive load of capacitance Cg. Each of output buffer 82, output buffer 83, output buffer 84, and output buffer 85 is an output buffer that has a current capacity (current supply capability) capable of driving a capacitive load of capacitance Cc.

Each address pulse generator 43 generates an address pulse in response to image data DQ output from corresponding latch 42. When image data DQ is “1” (Hi)”, the switching element for outputting voltage Vd on the high voltage side is set to ON so as to apply voltage Vd to corresponding data electrode 22. When image data DQ is “0” (Lo)”, the switching element for outputting voltage 0 (V) on the low voltage side is set to ON so as to apply voltage 0 (V) to corresponding data electrode 22.

Each address pulse generator 43 has five output buffers (output buffer 81-output buffer 85). In this exemplary embodiment, all of these five output buffers (output buffer 81-output buffer 85) are not always operated. The amount of current that can be supplied to data electrode 22 increases in proportion to the number of the output buffers operated. The amount of current that can be supplied to data electrode 22 when five output buffers are operated is the larger than that when only one output buffer is operated. However, as the amount of current that can be supplied to data electrode 22 increases, the amount of current instantaneously flowing in the generation of the address pulse also increases, which increases unnecessary radiation. In contrast, if the amount of current that can be supplied from address pulse generator 43 is not sufficient when a large amount of current needs to be applied to data electrode 22, the address pulse cannot rise properly. This makes the address discharge unstable.

With these facts taken into account, in this exemplary embodiment, the number of the output buffers to be operated is changed based on the calculation results in address pulse controller part 144, and address pulses are generated. This operation will be detailed later.

Address pulse controller part 144 includes load calculators 44 equal in number to latches 41 in shift register part 141. Load calculators 44 correspond to respective data electrodes 22 to be driven by data driver 40. The output signal from each load calculator 44 is input to corresponding address pulse generator 43. Each load calculator 44 has self-load calculator 50, adjacent load calculator 60, and output buffer controller 70. Based on image data Q, each load calculator calculates the magnitude of the load capacitance in corresponding data electrode 22 to be driven by data driver 40. For example, load calculator 44j has self-load calculator 50j, adjacent load calculator 60j, and output buffer controller 70j, and calculates the magnitude of the load capacitance of data electrode Dj, based on image data Qj.

In data driver 40, the number of the output buffers to be operated in each address pulse generator 43 is determined based on the calculation result in corresponding load calculator 44.

In this exemplary embodiment, in data driver 40, each of the numbers of latches 42, address pulse generators 43, and load calculators 44 is equal to the number of latches 41 in shift register part 141. However, each of the numbers of latches 41, latches 42, address pulse generators 43, and load calculators 44 may be equal to or greater than the number of data electrodes to be driven by data driver 40.

Next, each load calculator 44 is detailed.

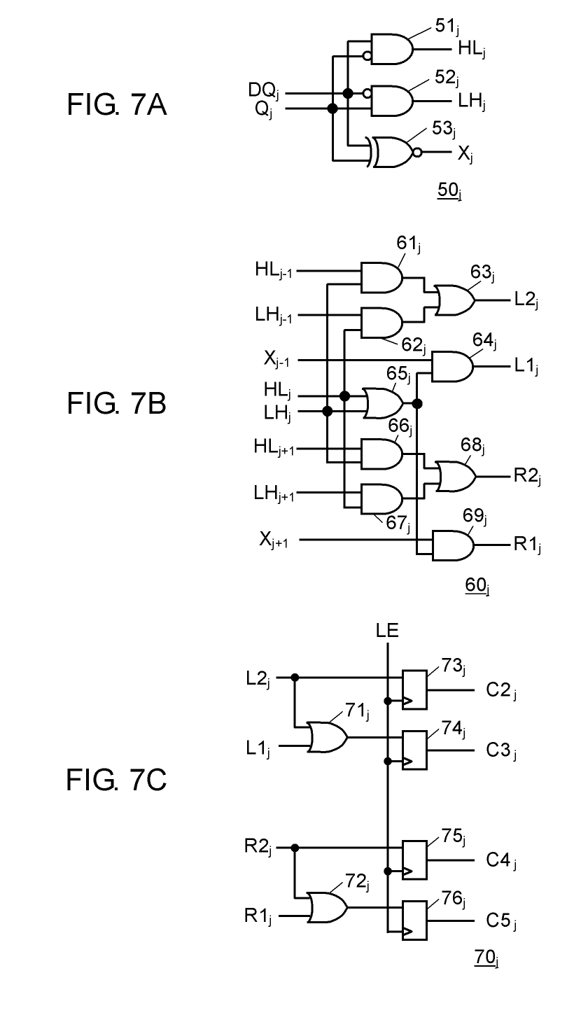

FIG. 7A is a circuit diagram of self-load calculator 50 in load calculator 44 in plasma display apparatus 30 in accordance with the exemplary embodiment of the present invention. FIG. 7B is a circuit diagram of adjacent load calculator 60 in load calculator 44 in plasma display apparatus 30 in accordance with the exemplary embodiment of the present invention. FIG. 7C is a circuit diagram of output buffer controller 70 in load calculator 44 in plasma display apparatus 30 in accordance with the exemplary embodiment of the present invention.

In this exemplary embodiment, a description is provided for self-load calculator 50j, adjacent load calculator 60j, and output buffer controller 70j included in load calculator 44j corresponding to data electrode Dj. Each of the other load calculators 44 has an identical configuration.

As shown in FIG. 7A, self-load calculator 50j has logic gate 51j, logic gate 52j, and logic gate 53j. Image data corresponding to data electrode Dj, i.e. image data Qj and image data DQj, is input to each logic gate. In this exemplary embodiment, the output from logic gate 51j is output HLj, the output from logic gate 52j is output LHj, and the output from logic gate 53j is output Xj.

Self-load calculator 50j operates so as to detect how the address operation on the discharge cell in the line one line (one horizontal synchronization period) preceding the line of a focused discharge cell is with respect to the address operation on the focused discharge cell. Here, for instance, when the address operation is performed on the respective discharge cells of panel 10 sequentially from the upper lines to the lower lines, the discharge cell in the line one-line-preceding the line of a focused discharge cell is the discharge cell just above the focused discharge cell. When the address operation is performed on the respective discharge cells of panel 10 sequentially from the lower lines to the upper lines, the discharge cell just under the focused discharge cell is the discharge cell in the line one-line-preceding the line of the focused discharge cell. In the case of so-called interlaced scanning, i.e. when the address operation is performed on odd-numbered lines first and on even-numbered lines next, the discharge cell just above or just under the focused discharge cell via one discharge cell is the one-line-preceding discharge cell.

In this manner, in this exemplary embodiment, the “one-line-preceding discharge cell” is the discharge cell in the line one line (one horizontal synchronization period) preceding the line of a focused discharge cell in the address operation, and is not limited to the discharge cell that is adjacent to the focused discharge cell in the extending direction of data electrode 22 (the discharge cell adjacent just above or just under the focused discharge cell of panel 10).

Self-load calculator 50j compares the address operation on a focused discharge cell (e.g. a discharge cell in a part where data electrode Dj intersects scan electrode SCi and sustain electrode SUi) with the address operation on a one-line-preceding discharge cell (e.g. a discharge cell in a part where data electrode Dj intersects scan electrode SCi−1 and sustain electrode SUi−1). That is, self-load calculator 50j detects a relative change between the address pulse applied to a focused discharge cell on data electrode Dj and the address pulse applied to the one-line-preceding discharge cell of the focused discharge cell on data electrode Dj.

For this purpose, self-load calculator 50j needs to compare image data DQj(i) of the focused discharge cell with image data DQj(i−1) of the one-line-preceding discharge cell of the focused discharge cell.

Image data Qj is serial data as described above, and includes image data Qj(i) corresponding to image data DQj(i) of the focused discharge cell. Therefore, appropriately delaying image data DQj that is output from latch 42j and input to self-load calculator 50j can make an instant when the timing of image data DQj(i−1) of the one-line-preceding discharge cell of the focused discharge cell is matched with the timing of image data Qj(i) corresponding to image data DQj(i) of the focused discharge cell in self-load calculator 50j. In this diagram, the circuit for this delay is omitted. At timings except this timing, unnecessary calculation results, such as that of image data DQj(i−1) and image data DQj−1(i) and that of image data DQj(i−1) and image data DQj+1(i), are output.

Therefore, load calculator 44j needs to perform an operation of holding the calculation result obtained at an appropriate timing when the necessary logic operation is performed in self-load calculator 50j. The part that performs the operation is output buffer controller 70j at the subsequent stage. That is, in this exemplary embodiment, output buffer controller 70j is operated so as to hold the data obtained at an appropriate timing when the necessary logic operation is performed.

Hereinafter, for ease of explanation, a description is provided for a case where image data DQj input to self-load calculator 50j is image data DQj(i−1) of the one-line-preceding discharge cell of a focused discharge cell, and image data Qj is image data DQj(i) of the focused discharge cell.

Each of logic gate 51j and logic gate 52j is a logic gate for performing an AND operation. Only when the signals input to two input terminals are both “1 (Hi)”, this logic gate outputs “1 (Hi)”, and otherwise outputs “0 (Lo)”. In the diagram, each of logic gate 51j and logic gate 52j has a circular mark on one of the input terminals. This mark represents an inverter, which performs a logic inversion operation (an operation of inverting “1” to “0”, and “0” to “1”). Therefore, image data Qj is logically inverted and input to logic gate 51j; image data DQj is logically inverted and input to logic gate 52j. That is, when image data DQj is “1” and image data Qj is “0”, logic gate 51j outputs “1”, and otherwise outputs “0”. When image data DQj is “0” and image data Qj is “1”, logic gate 52j outputs “1”, and otherwise outputs “0”.

Logic gate 53j is a logic gate for performing an exclusive OR operation. Only when one of the signals input to the two input terminals is “0” and the other is “1”, the operation result is “1”. When the signals input to the two input terminals are both “0” or are both “1”, the operation result is “0”. Since the output terminal of logic gate 53j has a circular mark in the drawing, the operation result in logic gate 53j is logically inverted for output. Therefore, logic gate 53j outputs “1” only when image data DQj and image data Qj are both “0” or are both “1”, and otherwise outputs “0”.

As a result, in self-load calculator 50j, when the one-line-preceding discharge cell of a focused discharge cell is lit and the focused discharge cell is unlit, i.e. image data DQj(i−1) is “1” and image data Qj(i) is “0”, output HLj from logic gate 51j is “1” and output LHj and output Xj are both “0”. When the one-line-preceding discharge cell of a focused discharge cell is unlit and the focused discharge cell is lit, i.e. image data DQj(i−1) is “0” and image data DQj(i) is “1”, output LHj from logic gate 52j is “1” and output HLj and output Xj are both “0”. When the one-line-preceding discharge cell of a focused discharge cell is unlit and the focused discharge cell is unlit, i.e. image data DQj(i−1) is “0” and image data DQj(i) is “0”, and when the one-line-preceding discharge cell of a focused discharge cell is lit and the focused discharge cell is lit, i.e. image data DQj(i−1) is “1” and image data DQj(i) is “1”, output Xj from logic gate 53j is “1” and output HLj and output LHj are both “0”.

As shown in FIG. 7B, adjacent load calculator 60j has logic gate 61j, logic gate 62j, logic gate 63j, logic gate 64j, logic gate 65j, logic gate 66j, logic gate 67j, logic gate 68j, and logic gate 69j.

The adjacent load calculator calculates the magnitude of the load with respect to capacitance Cc between data electrode Dj and data electrode Dj−1 and between data electrode Dj and data electrode Dj+1, based on the output from self-load calculator 50j corresponding to data electrode Dj, the output from self-load calculator 50j−1 corresponding to data electrode Dj−1 adjacent to data electrode Dj, and the output from self-load calculator 50j+1 corresponding to data electrode Dj+1 adjacent to data electrode Dj. That is, the adjacent load calculator calculates the load capacitance in data electrode 22 corresponding to the focused discharge cell by comparing the image data of the focused discharge cell with the image data of the discharge cells adjacent to the focused discharge cell in the extending direction of display electrode pair 14.

Each of logic gate 61j, logic gate 62j, logic gate 64j, logic gate 66j, logic gate 67j, and logic gate 69j is a logic gate for performing an AND operation. Each of logic gate 63j, logic gate 65j, and logic gate 68j is a logic gate for performing an OR operation. Only when the signals input to the two input terminals are both “0”, the logic gates for performing an OR operation outputs “0”, and otherwise outputs “1”.

Output HLj−1, i.e. the output from self-load calculator 50j−1, and output LHj, i.e. the output from self-load calculator 50j, are input to logic gate 61j. Only when each input is “1”, the logic gate outputs “1”, and otherwise outputs “0”.

Output LHj−1, i.e. the output from self-load calculator 50j−1, and output HLj, i.e. the output from self-load calculator 50j, are input to logic gate 62j. Only when each input is “1”, the logic gate outputs “1”, and otherwise outputs “0”.

Output HLj+1, i.e. the output from self-load calculator 50j+1, and output LHj, i.e. the output from self-load calculator 50j, are input to logic gate 66j. Only when each input is “1”, the logic gate outputs “1”, and otherwise outputs “0”.

Output LHj+1, i.e. the output from self-load calculator 50j+1, and output HLj, i.e. the output from self-load calculator 50j, are input to logic gate 67j. Only when each input is “1”, the logic gate outputs “1”, and otherwise outputs “0”.

Output HLj and output LHj, i.e. the outputs from self-load calculator 50j, are input to logic gate 65j. Only when each input is “0”, the logic gate outputs “0”, and otherwise outputs “1”.

The output from logic gate 61j and the output from logic gate 62j are input to logic gate 63j. Only when each input is “0”, the logic gate outputs “0”, and otherwise outputs “1”.

The output from logic gate 66j and the output from logic gate 67j are input to logic gate 68j. Only when each input is “0”, the logic gate outputs “0”, and otherwise outputs “1”.

Output Xj−1, i.e. the output from self-load calculator 50j−1, and the output from logic gate 65j are input to logic gate 64j. Only when each input is “1”, the logic gate outputs “1”, and otherwise outputs “0”.

Output Xj+1, the output from self-load calculator 50j+1, and the output from logic gate 65j are input to logic gate 69j. Only when each input is “1”, the logic gate outputs “1”, and otherwise outputs “0”.

In this exemplary embodiment, the output from logic gate 63j is output L2j, the output from logic gate 64j is output L1j, the output from logic gate 68j is output R2j, and the output from logic gate 69j is output R1j.

Therefore, in adjacent load calculator 60j, the following results are obtained. In the case where a change between the lines in image data Qj−1 of data electrode Dj−1 adjacent to data electrode Dj on the left side (a change from image data DQj−1(i−1) to image data DQj−1(i)) is in opposite phase with a change between the lines in image data Qj of data electrode Dj (a change from image data DQj(i−1) to image data DQj(i)), the output from logic gate 61j or logic gate 62j is “1” and output L2j from logic gate 63j is “1”.

In the case where image data Qj of data electrode Dj is changed between the lines (the value of image data DQj(i−1) is different from the value of image data DQj(i)), and image data Qj−1 of data electrode Dj−1 adjacent to data electrode Dj on the left side is not changed between the lines (the value of image data DQj−1(i−1) is equal to the value of image data DQj−1(i)), output L1j from logic gate 64j is “1”.

Similarly, in the case where a change between the lines in image data Qj+1 of data electrode Dj+1 adjacent to data electrode Dj on the right side (a change from image data DQj+1(i−1) to image data DQj+1(i)) is in opposite phase with a change between the lines in image data Qj of data electrode Dj (a change from image data DQj(i−1) to image data DQj(i)), the output from logic gate 66j or logic gate 67j is “1” and output R2j from logic gate 68j is “1”.

In the case where image data Qj of data electrode Dj is changed between the lines (the value of image data DQj(i−1) is different from the value of image data DQj(i)), and image data Qj+1 of data electrode Dj+1 adjacent to data electrode Dj on the right side is not changed between the lines (the value of image data DQj+1(i−1) is equal to the value of image data DQj+1(i)), output R1j from logic gate 69j is “1”.

As shown in FIG. 7C, output buffer controller 70j has logic gate 71j, logic gate 72j, latch 73j, latch 74j, latch 75j, and latch 76j. Further, the output buffer controller outputs control signal C2j, control signal C3j, control signal C4j, and control signal C5j for controlling output buffer 82j, output buffer 83j, output buffer 84j, and output buffer 85j, respectively, included in address pulse generator 43j. Control signal C2j controls the operation (ON)/non-operation (OFF) of output buffer 82j. Control signal C3j controls ON/OFF of output buffer 83j. Control signal C4j controls ON/OFF of output buffer 84j. Control signal C5j controls ON/OFF of output buffer 85j.

The number of latches in output buffer controller 70j is set so as to correspond to the number of the output buffers in address pulse generator 43j.

Each of logic gate 71j and logic gate 72j is a logic gate for performing an OR operation.

Output L1j and output L2j output from adjacent load calculator 60j are input to logic gate 71j. Only when each input is “0”, the logic gate outputs “0”, and otherwise outputs “1”.

Output R1j and output R2j output from adjacent load calculator 60j are input to logic gate 72j. Only when each input is “0”, the logic gate outputs “0”, and otherwise outputs “1”.

As a synchronization signal, timing signal LE generated in timing generation circuit 35 is input to latch 73j, latch 74j, latch 75j, and latch 76j. A change in this synchronization signal (e.g. a change from the Lo state to the Hi state) triggers an input signal to be output. In FIG. 6, this timing signal LE is omitted.

Output L2j output from adjacent load calculator 60j is input to latch 73j. The output signal from latch 73j is supplied to output buffer 82j as control signal C2j.

The output signal from logic gate 71j is input to latch 74j. The output signal from latch 74j is supplied to output buffer 83j as control signal C3j.

Output R2j output from adjacent load calculator 60j is input to latch 75j. The output signal from latch 75j is supplied to output buffer 84j as control signal C4j.

The output signal from logic gate 72j is input to latch 76j. The output signal from latch 76j is supplied to output buffer 85j as control signal C5j.

Timing signal LE is a periodic pulse waveform of positive polarity normally in the Lo state and in the Hi state only in a period equal to one clock period of clock signal Dck, for example. The cycle in which timing signal LE becomes Hi is equal to the cycle in which the address pulses are generated. As described above, timing signal LE is generated in timing generation circuit 35 so as to allow latch 73j, latch 74j, latch 75j, and latch 76j to hold the above operation results obtained at the instant when the timing of image data DQj(i−1) is matched with the timing of image data Qj(i) corresponding to image data DQj(i). In latch 73j, latch 74j, latch 75j, and latch 76j, the timing of the output signals are appropriately adjusted such that control signal C2j, control signal C3j, control signal C4j, and control signal C5j are updated in synchronization with the timing at which an address pulse is output from address pulse generator 43j.

With the operation of these circuits, output buffer controller 70j outputs control signals in the following six patterns. For instance, suppose image data Qj of data electrode Dj is changed between the lines (the value of image data DQj(i−1) is different from the value of image data DQj(i)), and a change between the lines in image data Qj−1 of data electrode Dj−1 adjacent to data electrode Dj on the left side and a change between the lines in image data Qj+1 of data electrode Dj+1 adjacent to data electrode Dj on the right side are in phase with the change between the lines in image data Qj (the values of image data DQj−1(i−1) and image data DQj+1(i−1) are equal to the value of image data DQj(i−1), and the values of image data DQj−1(i) and image data DQj+1(i) are equal to the value of image data DQj(i)). In this case, output L2j, output L1j, output R2j, and output R1j from adjacent load calculator 60j are all “0”, and control signal C2j, control signal C3j, control signal C4j, and control signal C5j are all “0”. This is pattern A, which will be described later.

For instance, suppose image data Qj of data electrode Dj is changed between the lines (the value of image data DQj(i−1) is different from the value of image data DQj(i)), a change between the lines in the image data of one of data electrode Dj−1 and data electrode Dj+1 adjacent to data electrode Dj is in phase with the change between the lines in image data Qj (e.g. the value of image data DQj−1(i−1) is equal to the value of image data DQj(i−1), and the value of image data DQj−1(i) is equal to the value of image data DQj(i)), and the image data of the other of the data electrodes is not changed between the lines (e.g. the value of image data DQj+1(i−1) is equal to the value of image DQj+1(i)). In this case, only one of output L1j and output R1j from adjacent load calculator 60j is “1”, and the other of output L1j and output R1j, as well as output L2j and output R2j are “0”. Therefore, one of four control signal C2j-control signal C5j is “1” and the remaining three are “0”. This is pattern B, which will be described later.

For instance, suppose image data Qj of data electrode Dj is changed between the lines (the value of image data DQj(i−1) is different from the value of image data DQj(i)) and neither of image data Qj−1 of data electrode Dj−1 and image data Qj+1 of data electrode Dj+1 adjacent to data electrode Dj is changed between the lines (the value of image data DQj−1(i−1) is equal to the value of image data DQj−1(i), and the value of image data DQj+1(i−1) is equal to the value of image data DQj+1(i)). Alternatively, suppose image data Qj is changed between the lines, a change between the lines in the image data of one of data electrode Dj−1 and data electrode Dj+1 is in opposite phase with the change between the lines in image data Qj (e.g. the value of image data DQj−1(i−1) is different from the value of image data DQj(i−1), and the value of image data DQj−1(i) is different from the value of image data DQj(i)), and a change between the lines in the image data of the other of the data electrodes is in phase with the change between the lines in image data Qj (e.g. the value of image data DQj+1(i−1) is equal to the value of image data DQj(i−1), and the value of image data DQj+1(i) is equal to the value of image data DQj(i)). In these cases, output L1j and output R1j from adjacent load calculator 60j are both “1” and the remaining outputs are “0”, or only one of output L2j and output R2j is “1” and the remaining outputs are “0”. Therefore, two of four control signal C2j-control signal C5j are “1” and the remaining two are “0”. This is pattern C or pattern D, which will be described later.

For instance, suppose image data Qj of data electrode Dj is changed between the lines (the value of image data DQj(i−1) is different from the value of image data DQj(i)), a change between the lines in the image data of one of data electrode Dj−1 and data electrode Dj+1 adjacent to data electrode Dj is in opposite phase with the change between the lines in image data Qj (e.g. the value of image data DQj−1(i−1) is different from the value of image data DQj(i−1), and the value of image data DQj−1(i) is different from the value of image data DQj(i)), and the image data of the other of the data electrodes is not changed between the lines (e.g. the value of image data DQj+1(i−1) is equal to the value of image DQj+1(i)). In this case, only one of output L2j and output R2j from adjacent load calculator 60j is “1”. In the case where output L2j is “1”, output R1j is “1”. In the case where output R2j is “1”, output L1j is “1”. Therefore, three of four control signal C2j-control signal C5j are “1” and the remaining one is “0”. This is pattern E, which will be described later.

For instance, suppose image data Qj of data electrode Dj is changed between the lines (the value of image data DQj(i−1) is different from the value of image data DQj(i)), changes between the lines in image data Qj−1 of data electrode Dj−1 and image data Qj+1 of data electrode Dj+1 adjacent to data electrode Dj are in opposite phase with the change between the lines in image data Qj (the values of image data DQj−1(i−1) and image data DQj+1(i−1) are different from the value of DQj(i−1), and the values of image data DQj−1(i) and image data DQj+1(i) are different from the value of DQj(i)). In this case, output L2j and output R2j from adjacent load calculator 60j are both “1”. Therefore, four control signal C2j-control signal C5j are all “1”. This is pattern F, which will be described later.

As described above, in address pulse generator 43j included in address pulse output part 143, the respective outputs of five output buffers (output buffer 81j, output buffer 82j, output buffer 83j, output buffer 84j, and output buffer 85j) are connected in parallel with each other. Output buffer 81j has a current capacity (current supply capability) capable of driving a capacitive load of capacitance Cg. Each of output buffer 82j-output buffer 85j has a current capacity (current supply capability) capable of driving a capacitive load of capacitance Cc.

Output buffer 81j always operates irrespective of control signal C2j-control signal C5j, and generates an address pulse by outputting a voltage on the high voltage side or a voltage on the low voltage side of the address pulse in response to image data DQj of data electrode Dj. In contrast, the operation/non-operation of output buffer 82j-output buffer 85j is controlled by control signal C2j-control signal C5j. For example, output buffer 82j is controlled by control signal C2j in the following manner. When control signal C2j is “1 (Hi)”, the output buffer operates and generates an address pulse in response to image data DQj of data electrode Dj. When control signal C2j is “0 (Lo)”, output buffer 82j is in a non-operating state, where the output terminal is in a high impedance state and is not involved in the generation of an address pulse. Similarly, the operation/non-operation of output buffer 83j, output buffer 84j, and output buffer 85j is controlled by control signal C3j, control signal C4j, and control signal C5j, respectively. When each control signal is “1 (Hi)”, the corresponding output buffer is in an operating state, where an address pulse is generated in response to image data DQj of data electrode Dj. When each control signal is “0 (Lo)”, the corresponding output buffer is in the non-operating state, where the output terminal is in the high impedance state and is not involved in the generation of an address pulse.

The above driving can make the transition time of the address pulse uniform with a predetermined time and suppress unnecessary radiation even when the image data is changed. Hereinafter, the reason is described.

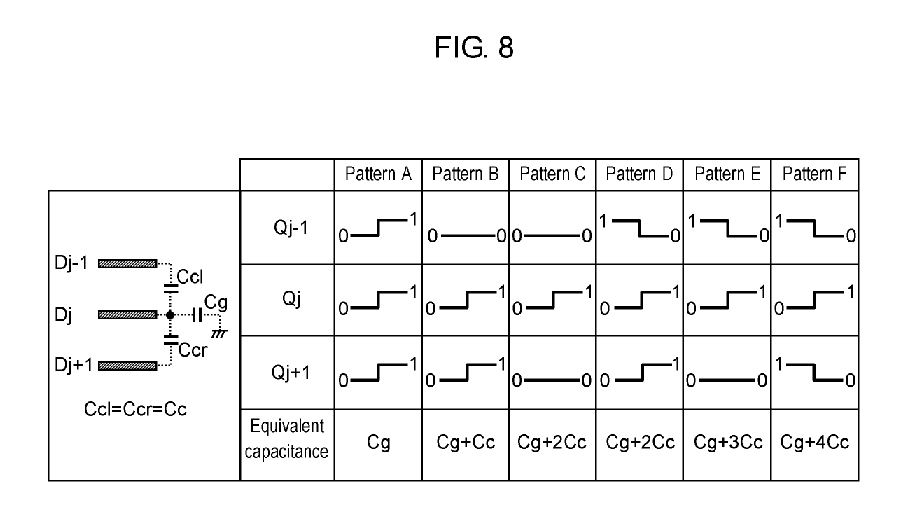

FIG. 8 is a diagram schematically showing load capacitance generated in one data electrode Dj in plasma display apparatus 30 in accordance with the exemplary embodiment of the present invention. FIG. 8 schematically shows a change between the lines in image data Qj of data electrode Dj, a change between the lines in image data Qj−1 of data electrode Dj−1, and a change between the lines in image data Qj+1 of data electrode Dj+1.

As described above, capacitance Cg is present between data electrode Dj and whole display electrode pairs 14, capacitance Cc (hereinafter, referred to as “capacitance Ccl”) is present between data electrode Dj and data electrode Dj−1 adjacent to data electrode Dj on the left side, and capacitance Cc (hereinafter, referred to as “capacitance Ccr”) is present between data electrode Dj and data electrode Dj+1 adjacent to data electrode Dj on the right side.

When image data Qj of data electrode Dj is changed from “0” to “1” between the lines, address pulse generator 43j needs to charge capacitance Cg. At this time, in the case where a change between the lines in image data Qj−1 of data electrode Dj−1 is in phase with the change between the lines in image data Qj, that is, the change is from “0” to “1”, capacitance Ccl does not need to be charged. Therefore, capacitance Ccl is substantially 0. Similarly, in the case where a change between the lines in image data Qj+1 of data electrode Dj+1 is in phase with the change between the lines in image data Qj, that is, the change is from “0” to “1”, capacitance Ccr does not need to be charged. Therefore, capacitance Ccr is also substantially 0. As a result, the load capacitance (equivalent capacitance) generated in data electrode Dj at this time is capacitance Cg. This is “pattern A” shown in FIG. 8.

For instance, suppose when image data Qj of data electrode Dj is changed from “0” to “1” between the lines, a change between the lines in image data Qj+1 of data electrode Dj+1 is in phase with the change between the lines in image data Qj, and image data Qj−1 of data electrode Dj−1 is not changed between the lines (from “0” to “0”, or from “1” to “1”). In this case, capacitance Ccr is substantially 0 but capacitance Ccl occurs. For this reason, address pulse generator 43j needs to charge capacitance Ccl in addition to capacitance Cg. Therefore, the load capacitance (equivalent capacitance) generated in data electrode Dj at this time is capacitance (Cg+Cc) (where capacitance Ccl=capacitance Cc). In the case where image data Qj+1 is not changed between the lines and a change between the lines in image data Qj−1 is in phase with the change between the lines in image data Qj, the same result is obtained. This is “pattern B” shown in FIG. 8.

For instance, suppose when image data Qj of data electrode Dj is changed from “0” to “1” between the lines, image data Qj−1 of data electrode Dj−1 and image data Qj+1 of data electrode Dj+1 are not changed between the lines (from “0” to “0”, or from “1” to “1”). In this case, both capacitance Ccl and capacitance Ccr occur. Therefore, the load capacitance (equivalent capacitance) generated in data electrode Dj at this time is capacitance (Cg+2Cc) (where capacitance Ccl=capacitance Ccr=capacitance Cc). This is “pattern C” shown in FIG. 8.

For instance, suppose when image data Qj of data electrode Dj is changed from “0” to “1” between the lines, a change between the lines in image data Qj+1 of data electrode Dj+1 is in phase with the change between the lines in image data Qj, and a change between the lines in image data Qj−1 of data electrode Dj−1 (from “1” to “0”) is in opposite phase with the change between the lines in image data Qj. In this case, capacitance Ccr is substantially 0, but address pulse generator 43j needs to charge capacitance Ccl against the change in image data Qj−1 in opposite phase. Thus, the current necessary for charging data electrode Dj is twice as large as that when image data Qj−1 is not changed between the lines. This is equivalent to the case where capacitance 2Ccl, which is twice as high as capacitance Ccl, is connected as a load. Therefore, the load capacitance (equivalent capacitance) generated in data electrode Dj at this time is capacitance (Cg+2Cc) (where capacitance Ccl=capacitance Cc). Also in the case where a change between the lines in image data Qj−1 is in phase with the change between the lines in image data Qj, and a change between the lines in image data Qj+1 is in opposite phase with the change between the lines in image data Qj, the same result is obtained. This is “pattern D” shown in FIG. 8.

For instance, suppose when image data Qj of data electrode Dj is changed from “0” to “1” between the lines, image data Qj+1 of data electrode Dj+1 is not changed between the lines (from “0” to “0”, or from “1” to “1”), and a change in image data Qj−1 of data electrode Dj−1 (from “1” to “0”) is in opposite phase with the change between the lines in image data Qj. In this case, address pulse generator 43j needs to charge capacitance Ccr and capacitance 2Ccl. Therefore, the load capacitance (equivalent capacitance) generated in data electrode Dj at this time is capacitance (Cg+3Cc) (where capacitance Ccl=capacitance Ccr=capacitance Cc). In the case where image data Qj−1 is not changed between the lines and a change between the lines in image data Qj+1 is in opposite phase with the change between the lines in image data Qj, the same result is obtained. This is “pattern E” shown in FIG. 8.

For instance, suppose when image data Qj of data electrode Dj is changed from “0” to “1” between the lines, a change between the lines in image data Qj−1 of data electrode Dj−1 and a change between the lines in image data Qj+1 of data electrode Dj+1 (from “1” to “0”) are in opposite phase with the change between the lines in image data Qj. In this case, address pulse generator 43j needs to charge capacitance 2Ccr and capacitance 2Ccl. Therefore, the load capacitance (equivalent capacitance) generated in data electrode Dj at this time is capacitance (Cg+4Cc) (where capacitance Ccl=capacitance Ccr=capacitance Cc). This is “pattern F” shown in FIG. 8.

In this manner, depending on the image data, the magnitude of the load of data electrode Dj changes in five steps.

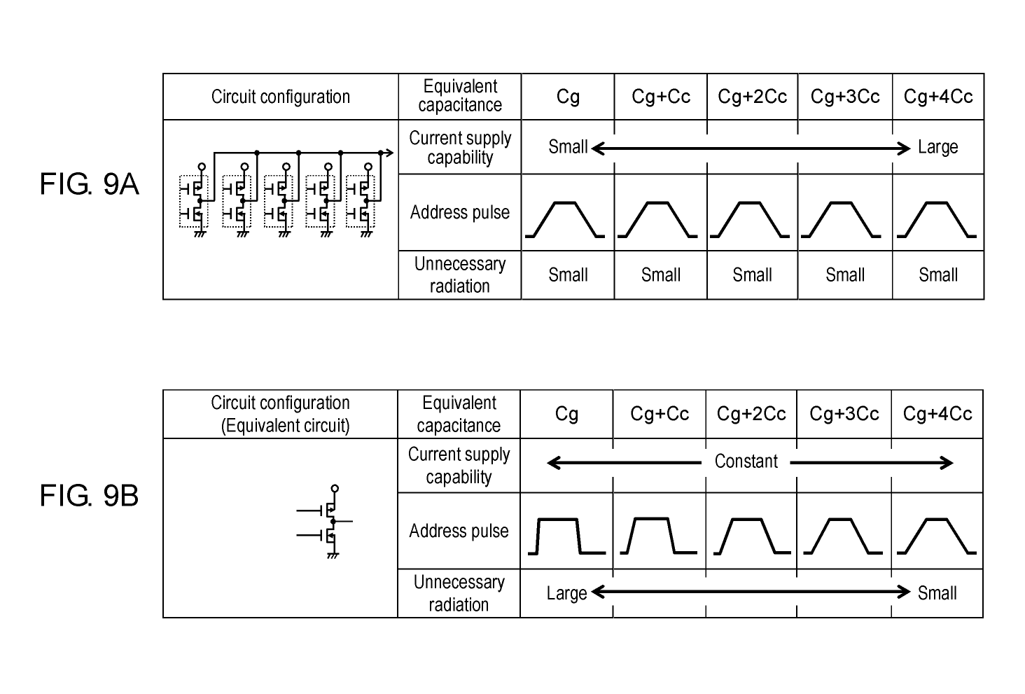

FIG. 9A and FIG. 9B are diagrams for comparing the conditions under which unnecessary radiation occurs in the plasma display apparatus. FIG. 9A is a diagram schematically showing the generation of unnecessary radiation when a plurality of output buffers included in address pulse generator 43 is operated adaptively to a display image in plasma display apparatus 30 in accordance with the exemplary embodiment of the present invention. FIG. 9B is a diagram schematically showing the generation of unnecessary radiation when all the plurality of output buffers in address pulse generator 43 is always operated in plasma display apparatus 30 in accordance with the exemplary embodiment. Each of FIG. 9A and FIG. 9B schematically shows the load capacitance (equivalent capacitance) generated in data electrode 22, the current that can be supplied from address pulse generator 43 (current supply capability), the waveform shape of the address pulse, and the unnecessary radiation. Incidentally, always operating all the plurality of output buffers (herein, output buffer 81-output buffer 85) in address pulse generator 43 is equivalent to operating one output buffer that has a current supply capability equal to the total current supply capability of these output buffers. Thus, FIG. 9B shows one output buffer only.

For instance, suppose when the drive load of data electrode 22 increases and thus a large amount of current needs to be supplied to data electrode 22, the amount of current that can be supplied from address pulse generator 43 is insufficient. In this case, the rising edge of the address pulse becomes gentle, which makes it difficult to cause an address discharge stably.

In order to prevent the above situation, the output buffers in address pulse generator 43 are set as follows. Even when the drive load of data electrode 22 is at the maximum, i.e. the load capacitance of data electrode 22 is capacitance (Cg+4Cc), the operation of all the output buffers in address pulse generator 43 enables the address pulse to rise with an appropriate transition time and thereby causes an address discharge stably, while suppressing the generation of unnecessary radiation.

However, when all the output buffers in address pulse generator 43 are always operated, an excessive current is supplied to data electrode 22. Thus, as shown in FIG. 9B, as the drive load of data electrode 22 decreases in the order of capacitance (Cg+3Cc), capacitance (Cg+2Cc), capacitance (Cg+Cc), and capacitance Cg, the rising edge of the address pulse gradually becomes steeper and thereby the instantaneously flowing current (peak current) increases so as to increase the unnecessary radiation.

However, if the current supply capability in address pulse generator 43 is adaptively changed in response to the image displayed on panel 10, i.e. in response to the drive load generated in data electrode 22, the current supply capability in address pulse generator 43 under a small drive load can be suppressed so as to prevent an increase in unnecessary radiation.

Then, in this exemplary embodiment, in response to the five states of the drive load—the capacitance of the drive load generated in data electrode 22, i.e. capacitance (Cg+4Cc), capacitance (Cg+3Cc), capacitance (Cg+2Cc), capacitance (Cg+Cc), and capacitance Cg, the five output buffers in address pulse generator 43 are operated adaptively. That is, when the drive load generated in data electrode 22 is at the maximum (capacitance (Cg+4Cc)), all the five output buffers in address pulse generator 43 are operated for the generation of an address pulse. When the drive load of data electrode 22 is capacitance (Cg+3Cc), output buffer 81 and three of the remaining four output buffers are operated for the generation of an address pulse. When the drive load of data electrode 22 is capacitance (Cg+2Cc), output buffer 81 and two of the remaining four output buffers are operated for the generation of an address pulse. When the drive load of data electrode 22 is capacitance (Cg+Cc), output buffer 81 and one of the remaining four output buffers are operated for the generation of an address pulse. When the drive load of data electrode 22 is capacitance Cg, only output buffer 81 is operated for the generation of an address pulse. This operation prevents the excessive current supply to data electrode 22 in the generation of an address pulse.

In this manner, the current supply capability in address pulse generator 43 is changed adaptively to the drive load generated in data electrode 22. Thereby, as shown in FIG. 9A, under an increased drive load of data electrode 22, the current supply capability in address pulse generator 43 can be increased for the generation of an address pulse. Under a decreased drive load of data electrode 22, the current supply capability in address pulse generator 43 can be decreased for the generation of an address pulse. This operation enables the address pulse to properly rise with an appropriate transition time and thereby causes an address discharge stably, while suppressing the generation of unnecessary radiation even when the drive load of data electrode 22 is changed.

In this exemplary embodiment, a description has been provided for the rising edge of an address pulse. Similarly, the above description is also applicable to the falling edge of the address pulse.

In this exemplary embodiment, a description has been provided for a configuration where each address pulse generator 43 in address pulse output part 143 of data driver 40 has five output buffers. However, each address pulse generator in the address pulse output part may have the number of the output buffers smaller than five.

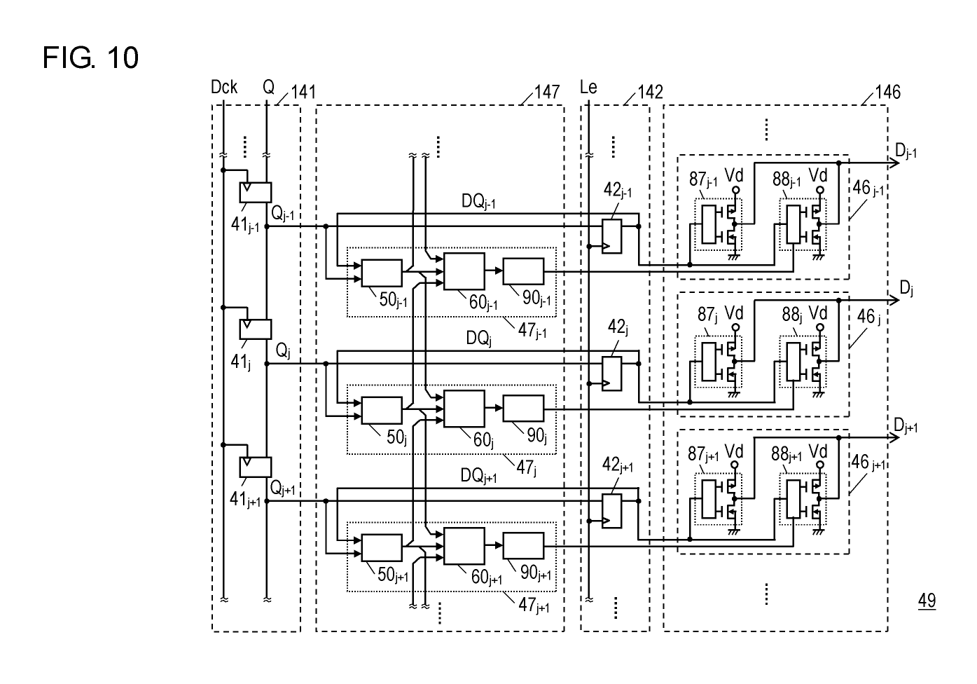

FIG. 10 is a circuit block diagram of data driver 49 in a plasma display apparatus in accordance with another exemplary embodiment of the present invention.

Data driver 49 includes shift register part 141, data latch part 142, address pulse output part 146, and address pulse controller part 147. In data driver 49, the circuit blocks operating in a manner similar to those in data driver 40 of FIG. 6 are denoted by the reference marks same as those of FIG. 6, and the description of these circuit blocks is omitted.

Address pulse output part 146 has address pulse generators 46 equal in number to latches 41 in shift register part 141, and generates address pulses to be applied to respective data electrodes 22 to be driven by data driver 49.

Each address pulse generator 46 has two output buffers connected in parallel with each other, i.e. output buffer 87 and output buffer 88. The basic operations of the respective output buffers are similar to those of the output buffers in address pulse generator 43, and the description of these output buffers is omitted.

Output buffer 87 has a current supply capability equal to that when output buffer 81 and output buffer 82 in address pulse generator 43 are operated simultaneously. Output buffer 88 has a current supply capability equal to that when output buffer 83, output buffer 84, and output buffer 85 in address pulse generator 43 are operated simultaneously. Therefore, the current supply capability when output buffer 87 and output buffer 88 are operated simultaneously is equal to the current supply capability when the five output buffers in address pulse generator 43 are operated simultaneously.

Address pulse controller part 147 has load calculators 47 equal in number to latches 41 in shift register part 141.

Each load calculator 47 has self-load calculator 50, adjacent load calculator 60, and output buffer controller 90. The operation of self-load calculator 50 and adjacent load calculator 60 is similar to the operation of self-load calculator 50 and adjacent load calculator 60 in load calculator 44 of FIG. 6, and thus the description of these calculators is omitted.

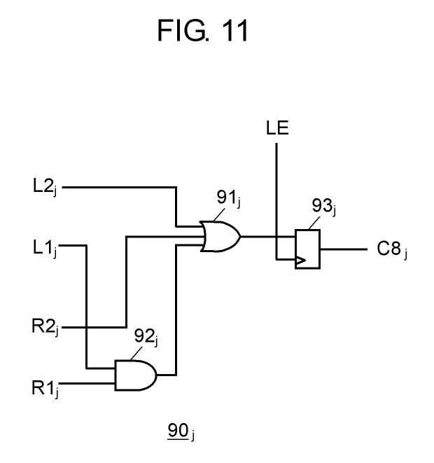

FIG. 11 is a circuit diagram of output buffer controller 90 in load calculator 47 in the plasma display apparatus in accordance with the other exemplary embodiment of the present invention.

In this exemplary embodiment, a description is provided for output buffer controller 90j in load calculator 47j corresponding to data electrode Dj. Each of the other load calculators 47 has an identical configuration.

As shown in FIG. 11, output buffer controller 90j has logic gate 91j, logic gate 92j, and latch 93j, and outputs control signal C8j for controlling the operation (ON)/non-operation (OFF) of output buffer 88j included in address pulse generator 46j.

Logic gate 91j is a logic gate for performing an OR operation, and logic gate 92j is a logic gate for performing an AND operation.

Output L1j and output R1j output from adjacent load calculator 60j are input to logic gate 92j. Only when each input is “1”, the logic gate outputs “1”, and otherwise outputs “0”.

Output L2j and output R2j output from adjacent load calculator 60j, and the output signal from logic gate 92j are input to logic gate 91j. Only when each input is “0”, the logic gate outputs “0”, and otherwise outputs “1”.

Timing signal LE is input to latch 93j as a synchronization signal. Timing signal LE triggers the signal output from logic gate 91j to be output. This output signal is supplied to output buffer 88j as control signal C8j.

With the operation of each of these circuits, control signal C8j output from output buffer controller 90j has the following values. In the above pattern A and pattern B, i.e. when the load capacitance of data electrode Dj is capacitance Cg or capacitance (Cg+Cc) (equal to or lower than capacitance (Cg+Cc)), the control signal is “0”. In the above pattern C, pattern D, pattern E, and pattern F, i.e. when the load capacitance of data electrode Dj is capacitance (Cg+2Cc), capacitance (Cg+3Cc), or capacitance (Cg+4Cc) (equal to or higher than capacitance (Cg+2Cc)), control signal C8j is “1”.

Output buffer 87j in address pulse generator 46j always operates irrespective of control signal C8j. Output buffer 88j is in the operating (ON) state when control signal C8j is “1”, and in the non-operating (OFF) state when control signal C8j is “0”.

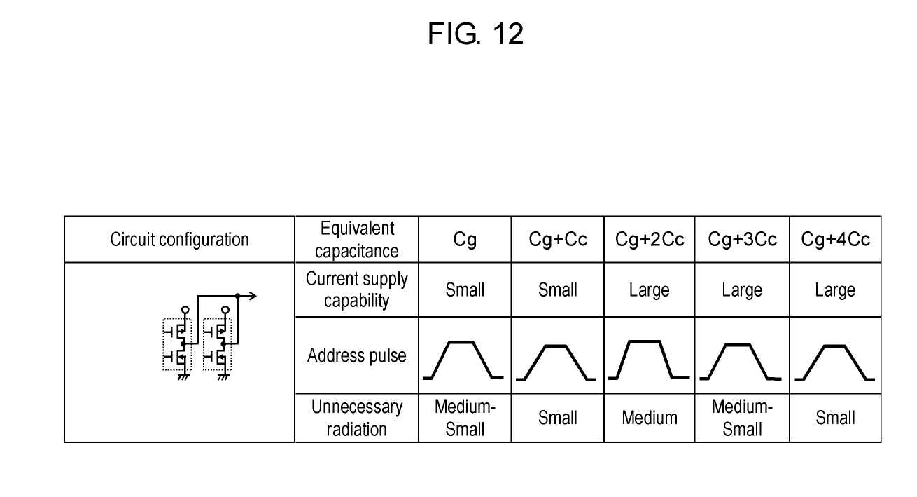

FIG. 12 is a diagram schematically showing the generation of unnecessary radiation when two output buffers included in address pulse generator 46 are operated adaptively to a display image in the plasma display apparatus in accordance with the other exemplary embodiment of the present invention.

In address pulse generator 46j, only output buffer 87j is used for the generation of an address pulse when the load capacitance of data electrode Dj is capacitance (Cg+Cc) or capacitance Cg.

As described above, output buffer 87 has a current supply capability equal to that when output buffer 81 and output buffer 82 in address pulse generator 43 are operated simultaneously. Thus, when the load capacitance of data electrode Dj is capacitance (Cg+Cc), the current supply capability in address pulse generator 46j is substantially equal to the current supply capability in address pulse generator 43 of FIG. 6 operating under the same condition. Therefore, as shown in FIG. 12, the address pulse can rise properly with an appropriate transition time so as to cause an address discharge stably, while the generation of unnecessary radiation is suppressed.

However, when the load capacitance of data electrode Dj is capacitance Cg, the current supply capability in address pulse generator 46j is larger than the current supply capability in address pulse generator 43 that operates output buffer 81j only.

Further, when the load capacitance of data electrode Dj is capacitance (Cg+2Cc), capacitance (Cg+3Cc), or capacitance (Cg+4Cc), address pulse generator 46j uses output buffer 87j and output buffer 88j for the generation of an address pulse.

As described above, output buffer 88 has a current supply capability equal to that when output buffer 83, output buffer 84, and output buffer 85 in address pulse generator 43 are operated simultaneously. Thus, when the load capacitance of data electrode Dj is capacitance (Cg+4Cc), the current supply capability in address pulse generator 46j is substantially equal to the current supply capability in address pulse generator 43 of FIG. 6 operating under the same condition. Therefore, the address pulse can rise properly with an appropriate transition time so as to cause an address discharge stably, while the generation of unnecessary radiation is suppressed.

However, when the load capacitance of data electrode Dj is capacitance (Cg+3Cc), the current supply capability in address pulse generator 46j is larger than the current supply capability in address pulse generator 43 that operates output buffer 81j-output buffer 84j. Further, when the load capacitance of data electrode Dj is capacitance (Cg+2Cc), the current supply capability in address pulse generator 46j is larger than the current supply capability in address pulse generator 43 that operates output buffer 81j-output buffer 83j.

As described above, as the current supply capability in address pulse generator 46j with respect to the load capacitance of data electrode Dj increases, the rising edge of the address pulse gradually becomes steeper, and thereby the instantaneously flowing current (peak current) increases so as to increase the unnecessary radiation. Therefore, as shown in FIG. 12, when the load capacitance of data electrode Dj is capacitance Cg, capacitance (Cg+3Cc), and capacitance (Cg+2Cc), the current supply capability is larger than that in address pulse generator 43 of FIG. 6 operating under the same conditions. This causes the address pulse to rise more steeply, and increases the instantaneously flowing current (peak current) so as to increase the unnecessary radiation.

However, even with such a configuration, the unnecessary radiation generated when the load capacitance of data electrode Dj is capacitance Cg and capacitance (Cg+Cc) can be suppressed lower than that when all the output buffers are always operated. Further, as long as the unnecessary radiation is within the range of a predetermined standard on the unnecessary radiation, no problem arises.

In this manner, as long as the unnecessary radiation can be kept within the range of the predetermined standard on the unnecessary radiation, the data driver can be formed with a simplified circuit configuration such that the number of the output buffers in each address pulse generator in the address pulse output part is smaller than five.

In the configuration described in the exemplary embodiments, shift register part 141 has one shift register, and one set of serial image data Q is input to shift register part 141. However, the present invention is not limited to this configuration. For example, the following configuration may be used. The shift register part includes three shift registers corresponding to image data Qr of red primary color signals, image data Qg of green primary color signals, and image data Qb of blue primary color signals. Further, image data Qr, image data Qg, and image data Qb are rearranged in accordance with the order of the arrangement of data electrodes 22, as image data Q.

The specific circuit configurations of the exemplary embodiments are shown as examples of circuit configurations, and the present invention is not limited to these circuit configurations. As long as the above functions are implemented, other circuit configurations may be used. Each latch in the exemplary embodiments may be operated in response to a negative synchronization signal, and the synchronization signal to be input to each latch may be a negative pulse signal.

The specific numerical values in the exemplary embodiments of the present invention simply show examples, and the present invention is not limited to these numerical values. Preferably, each numerical value is set optimally for the characteristics of the panel, the specifications of the plasma display apparatus, or the like.

### INDUSTRIAL APPLICABILITY

The present invention is capable of causing a stable address discharge while suppressing unnecessary radiation, e.g. line radiation and housing radiation, and thus is useful as a plasma display apparatus and a driving method for a panel.

### REFERENCE MARKS IN THE DRAWINGS

10 Panel
11 Front substrate
12 Scan electrode
13 Sustain electrode
14 Display electrode pair
15, 23 Dielectric layer
16 Protective layer
21 Rear substrate
22 Data electrode
24 Barrier rib
25 Phosphor layer
30 Plasma display apparatus
31 Image signal processing circuit
32 Data electrode driver circuit
33 Scan electrode driver circuit
34 Sustain electrode driver circuit
35 Timing generation circuit
40, 49 Data driver
41, 42, 73, 74, 75, 76, 93 Latch
43, 46 Address pulse generator
44, 47 Load calculator
50 Self-load calculator
51, 52, 53, 61, 62, 63, 64, 65, 66, 67, 68, 69, 71, 72, 91, 92 Logic gate
60 Adjacent load calculator
70, 90 Output buffer controller
81, 82, 83, 84, 85, 87, 88 Output buffer
141 Shift register part
142 Data latch part
143, 146 Address pulse output part
144, 147 Address pulse controller part
Cg, Cc, Cs, Ccl, Ccr Capacitance

1. A plasma display apparatus comprising:
a plasma display panel having a plurality of discharge cells, each of the discharge cells having a display electrode pair and a data electrode, the display electrode pair including a scan electrode and a sustain electrode; and
a driver circuit for driving the plasma display panel in a manner such that one field is formed of a plurality of subfields and each of the subfields includes an address period, the driver circuit including:
an image signal processing circuit for generating image data that represents light emission and no light emission in each discharge cell in each subfield, based on an image signal; and
a data electrode driver circuit for generating an address pulse based on the image data and applying the address pulse to the corresponding data electrode,
wherein the data electrode driver circuit includes a plurality of output buffers for each data electrode, each of the output buffers having a predetermined current supply capability and applying the address pulse to the corresponding data electrode,
based on the image data, the data electrode driver circuit calculates a load capacitance of each data electrode, and
based on the load capacitance, the data electrode driver circuit changes number of the output buffers to be used in the application of the address pulse to the corresponding data electrode.

2. The plasma display apparatus of claim 1, wherein when the load capacitance is low, the data electrode driver circuit makes the number of the output buffers to be used in the application of the address pulse to the data electrode smaller than the number of the output buffers when the load capacitance is high such that the current supply capability with respect to the data electrode is reduced.

3. The plasma display apparatus of claim 1, wherein the data electrode driver circuit calculates the load capacitance by comparing the image data of a focused discharge cell with the image data of a discharge cell having undergone an address operation one horizontal synchronization period before the address operation on the focused discharge cell.

4. The plasma display apparatus of claim 3, wherein the data electrode driver circuit calculates the load capacitance by comparing the image data of the focused discharge cell with the image data of a discharge cell adjacent to the focused discharge cell in an extending direction of the display electrode pair.

5. A driving method for a plasma display panel,
the plasma display panel having a plurality of discharge cells, each of the discharge cells having a display electrode pair and a data electrode, the display electrode pair including a scan electrode and a sustain electrode,
the plasma display panel being driven in a manner such that one field is formed of a plurality of subfields and each of the subfields includes an address period,
the driving method comprising:
based on an image signal, generating image data that represents light emission and no light emission in each discharge cell in each subfield;
generating an address pulse based on the image data, and applying the address pulse to the corresponding data electrode, using at least one output buffer, the output buffer having a predetermined current supply capability;
based on the image data, calculating a load capacitance of each data electrode; and
based on the load capacitance, changing number of the output buffers to be used in the application of the address pulse to the corresponding data electrode.

6. The driving method for the plasma display panel of claim 5, wherein when the load capacitance is low, the number of the output buffers to be used in the application of the address pulse to the data electrode is made smaller than the number of the output buffers when the load capacitance is high such that the current supply capability with respect to the data electrode is reduced.
